(19) United States
(12) Patent Application Publication
(10) Pub. No.: US 2015/0269594 A1
(43) Pub. Date: Sep. 24, 2015

(54) SYSTEM, METHOD AND COMPUTER ACCESSIBLE MEDIUM FOR CUSTOMER ACQUISITION USING SOCIAL TARGETING

(71) Applicant: NEW YORK UNIVERSITY, New York, NY (US)

(72) Inventors: Foster Provost, New York, NY (US); David Martens, Berchem (BE)

(73) Assignee: New York University, New York, NY (US)

(21) Appl. No.: 14/435,587

(22) PCT Filed: Oct. 14, 2013
(86) PCT No.: PCT/US2013/064834

§ 371 Date: Apr. 14, 2015

Related U.S. Application Data
(60) Provisional application No. 61/714,014, filed on Oct. 15, 2012.

(51) Int. Cl. G06Q 30/02; G06F 17/30

(52) U.S. Cl. CPC G06Q 30/0201; G06F 17/30876; G06Q 30/0269; G06Q 50/01

(57) ABSTRACT

Exemplary systems, methods and computer accessible medium can be provided for customer acquisition using social targeting can receive first information regarding at least one customer user associated with a particular node, determine second information based, at least in part, on the first information, receive third information regarding at least one non-customer user associated with the particular node, and determine fourth information based, at least in part, on the second information and the third information.

### CROSS-REFERENCE TO RELATED APPLICATION(S)

This application relates to and claims priority from U.S. Patent Application No. 61/714,014, filed on Oct. 15, 2012, the entire disclosure of which is incorporated herein by reference.

### FIELD OF THE DISCLOSURE

The present disclosure relates generally to an acquisition of new customers, and/or providing offers to customers, using social targeting, and more specifically, to exemplary embodiments of systems, methods and computer-accessible mediums that can target new customers for acquisition, and draw inferences regarding the value of properties of consumers for whom key data is unavailable, using information on existing customers.

### BACKGROUND INFORMATION

Customer analytics procedures have been applied in various areas which can be categorized according to the different stages of the customer life cycle (e.g., customer acquisition, customer development and customer retention). Customer acquisition can entail selecting the right prospective customers, which could be measured by the response likelihood, purchase probability or customer lifetime value (“CLV”) of the customer. (See. e.g., Reference #2). Response modeling has been previously used (see, e.g., References #8; 17; 2; 12), along with CLV modeling (see, e.g., References #1; 4; 9; 6), and churn prediction (see, e.g., References #25; 3; 22; 23), while analytics for customer acquisition has been much less researched.

Analytics-driven marketing campaigns can be based on datasets containing Recency, Frequency and Monetary (“RFM”), psychographic and/or socio-demographic data, with labels that can indicate which of the customers are good prospects. A challenge within data-driven customer acquisition is that typically little or no data is available about a potential customer. (See. e.g., Reference #2). The key is to find data that is (i) available for both the existing customers and the prospective customers and (ii) predictive enough to distinguish “good/right” customers from the rest of the customers. Once a model is generated based on the existing customer base to identify the valuable customers, it can be applied to all prospective customers. RFM data, often used in customer analytics, often may not be available on prospective customers, and neither may be psychographic and/or demographic data, unless the consumer's identity is known relatively precisely when the analytics are performed and consumer-specific data is purchased from third parties. This may not be the case in many situations where prospective customers may be attracted with advertisements or other offers.

In the online world, other types of data have been used to overcome the lack of available data. Non-RFM behavioral data in the form of click-stream data, available on both existing customers and prospective customers, has been used to predict conversion behavior at e-commerce sites. (See, e.g., Reference #14). Textual data of companies' webpages has been used to discriminate between profitable and non-profitable customers, for example, in a business to business (“B2B”) setting, using a logistic regression model built on latent semantic indexing (“LSI”) defined concepts. (See, e.g., Reference #21). When applied to prospective customers' webpages, this approach can outperform traditional approaches of prospective customers acquired from list brokers by a wide margin.

Recently, alternative targeting designs, generally called social targeting, have been introduced. Social targeting can differ from the aforementioned targeting methods because it can rely on explicit linkages between specific individuals. For example, the remarkable effectiveness of social-network targeting (e.g., targeting consumers who are linked to known customers by a social network) has been shown. (See, e.g., Reference #7). Subsequently, Facebook, as well as other social networks, have attempted to implement social-network targeting for online advertising with varying degrees of success. Social targeting can be viewed in a broader manner, and several designs have been suggested based on transactional data of consumers to build a connections among the customers—forming what might be called a Consumer Network. For example, (i) linking customers of a bank when they make payments to the same entities (see, e.g., Reference #12), (ii) linking customers using mobile devices when they visit the same locations (see, e.g., Reference #18), or (iii) linking customers using browsers when they visit the same webpages. (See, e.g., Reference #19). These consumer networks do not necessarily embed a true social network, and they do not target true social-network neighbors, or actual friends, of existing customers.

A link between customer acquisition and retention has been identified in previous research (see, e.g., Reference #20), which found that low prices lead to higher customer acquisition, but also faster customer churn; similar results were obtained in other studies. (See, e.g., Reference #10).

Thus it may be beneficial to provide exemplary systems, methods and computer accessible mediums which can implement a network that can utilize social targeting to target new customers for acquisition, and/or can infer the values of properties of consumers for whom key data can be unavailable, based on the characteristics or the behavior of customers linked in the network for whom data can be available, and which can overcome at least some of the deficiencies described herein above.

### SUMMARY OF EXEMPLARY EMBODIMENTS

The linking of persons, or customers, or the linking of credit cards and/or debit cards, when the customer withdraws money from the same automated teller machine(s) (“ATM(s)”), can be used to infer unknown values of properties of consumers. These exemplary values can be used to acquire or target new customers to deliver offers for third-party partners, or to infer values that can be the basis for decisions about existing customers for whom key data can be unavailable. For example, the exemplary systems, methods and computer-accessible mediums can be used to determine new account properties (e.g., credit lines and fee structures), for newly acquired customers, “churn” propensity for existing customers based on their connections to former customers prior to the former customer's churning. The available data assets, and existing channels for customer acquisition, can be leveraged (e.g., in the banking industry or the like). A network of ATMs can provide a bank with behavioral data (e.g., estimated behavioral data) that is available both on the existing customer base and on any prospective customers, and can also serve as a channel through which to serve a personalized offering to a potential customer. For example, a bank could infer estimated income and other values for non-customers visiting an ATM based on the network connections to existing customers, and then offers can be presented on the ATM screen, or printed out, based on these values. As such, the ATM can be used as a new channel for customer acquisition.

When utilizing a multi-channel approach to manage customer acquisition (e.g., “the design, deployment, and evaluation of channels to enhance customer value through effective customer acquisition, retention and development”) (see, e.g., Reference #15), the different acquisition costs, and the different channels to acquire customers with different customer lifetime value (see, e.g., References #24; 16), can be taken into account. The cost of promotions through this channel is minimal, as the ATM machines are generally owned by the bank delivering the ad/offering. The value of the customers acquired can depend on the targeted prospects and their response rate, details of which will be described below.

These and other objects of the present disclosure can be achieved by provision of systems, methods and computer-accessible mediums for customer acquisition using social targeting which can receive first information regarding a customer user(s) associated with a particular node(s), determine second information based, at least in part, on the first information, receive third information regarding a non-customer user(s), or other low data user, associated with the particular node(s), and determine fourth information based, at least in part, on the second information and the third information.

In some exemplary embodiments, the first information can be characteristics of the customer user(s). The characteristics can include demographics, income, savings amount, buying habits and/or product preferences. The second information can be determined by aggregating characteristics of multiple customer users of the particular node(s). The second information can be determined using a bipartite graph. Top nodes of the bipartite graph correspond to an automated teller machine(s), and bottom nodes of the bipartite graph correspond to a bank card(s) of the customer user(s). The third information can be the usage of the particular node(s) by the non-customer user(s). The fourth information can be determined by inferring characteristics of the customer user(s) to the non-customer user(s). The fourth information can include the fourth information includes (i) demographics, (ii) income, (iii) savings amount, (iv) buying habits, and/or (v) product preferences of the non-customer user(s). The particular node(s) can be an automated teller machine. The particular node(s) include a plurality of particular nodes, and the second information can be determined based on the plurality of particular nodes. The fourth information is determined using an average or a weighted average of information related to the plurality of particular nodes. The particular node(s) can have a particular geo-location. The non-customer user(s) can be targeted for acquisition as a customer, and/or targeted for offers or advertisements. The non-customer user(s) can be tracked at a plurality of particular nodes. The data can be aggregated from a plurality of particular nodes.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is an exemplary flow diagram of a method for inferring information about existing customers according to an exemplary embodiment of the present disclosure;

FIG. 2 is an exemplary flow diagram of a method for a new customer acquisition targeting procedure according to an exemplary embodiment of the present disclosure;

FIGS. 3A and 3B are exemplary graphs of a synthetic city grid with income defined by a location;

FIG. 3C is an exemplary graph of the graph from FIG. 3A being slightly perturbated with the addition of noise;

FIG. 3D is an exemplary graph showing users making cash withdrawals at ATMs;

FIG. 4 is set of exemplary graphs, from top to bottom, of exemplary results of real, perturbated, inferred and weighted inferred income for a grid of 40×40 users and 1000 ATMs according to an exemplary embodiment of the present disclosure;

FIG. 5A is a set of exemplary graphs, from top to bottom, of exemplary results of real, perturbated, inferred and weighted inferred income for a grid of 8×8 users and 1000 ATMs according to another exemplary embodiment of the present disclosure;

FIG. 5B is a set of exemplary graphs, from top to bottom, of exemplary results of real, perturbated, inferred and weighted inferred incomes for a grid of 30×30 users and 1000 ATMs according to yet another exemplary embodiment of the present disclosure;

FIG. 6 is a set of exemplary graphs of an overall impact on a performance of increasing a number of users and transactions according to an exemplary embodiment of the present disclosure;

FIG. 7 is a set of exemplary graphs of an impact on the performance of inferred weighted income by increasing a number of users and transactions according to another exemplary embodiment of the present disclosure;

FIG. 8 is a set of exemplary graphs of the impact on the performance of increasing the number of users and ATMs according to still another exemplary embodiment of the present disclosure;

FIG. 9 is a set of exemplary graphs of the impact on performance of inferred weighted income by increasing the number of users and ATMs according to yet another exemplary embodiment of the present disclosure; and

FIG. 10 is an illustration of an exemplary block diagram of an exemplary system in accordance with certain exemplary embodiments of the present disclosure.

Throughout the drawings, the same reference numerals and characters, unless otherwise stated, are used to denote like features, elements, components, or portions of the illustrated embodiments. Moreover, while the present disclosure will now be described in detail with reference to the Figures, it is done so in connection with the illustrative embodiments and is not limited by the particular embodiments illustrated in the Figures, and appended claims.

### DETAILED DESCRIPTION OF EXEMPLARY EMBODIMENTS

The exemplary embodiments of the present disclosure can be further understood with reference to the following description and the related appended drawings. The exemplary embodiments of the present disclosure relate to exemplary systems, methods and computer-accessible mediums for targeting new customer acquisitions based on the inferred characteristics of current customers. For example, the exemplary systems, methods and computer-accessible mediums can utilize information about the use by current customers of a particular ATM machine to infer characteristics of the use of the ATM machine by non-customers. The exemplary embodiments are described with reference to ATM machines, although those having ordinary skill in the art will understand that the exemplary embodiments of the present disclosure can be implemented on other customer and non-customer use of a similar node—especially a physical node located at a specific location—that can create linkages between customers and non-customers, as well as in other environments and/or applications.

An ATM-Based Consumer Network can be defined by, for example, a set of nodes V_{ATM} and a set of potentially weighted edges E between them (e.g., G_{ATM}=<V_{ATM}, E>). The nodes can correspond to the set of unique debit/credit cards that have used the network of ATMs available to the bank, and each node can have its own profile. A further exemplary distinction can be made between cards (e.g., nodes) used at the ATM that belong to the bank (e.g., bank customers) N_{c}, and cards used at the ATM that belong to other banks (e.g., prospective customers) Nₚ, with N=N_{c}∪Nₚ. For cards that belong to the bank, a significant amount of data can be available, including socio-demographic data, RFM usage data, the financial products the customer has purchased, and the customer's credit history. For the prospective customers (e.g., non-customers of the bank using the bank's ATM network) little or no data can be available.

The ATM visitation data can be visualized as a bipartite graph G_{Bi}-_{ATM}=<V_{ATM}, V_{Cards}, E′> where the top nodes can correspond to ATMs, the bottom nodes can correspond to the bank cards, and edges only between top and bottom nodes can indicate that a bank card was used at a specific ATM. In what follows, for clarity to distinguish the two types of nodes we will refer to the top nodes as ATM nodes, and the bottom nodes as Card nodes, but as mentioned above, this should be seen to generalize naturally to other similar settings. A completely privacy-friendly setup can be employed, as the bank cards of the customers and the prospective customers, and the ATMs themselves, can be identified by codes (e.g., a hash), not requiring a name, account number or other information. In the case of the cards, the code (e.g., hash) could be reversible in order to target a consumer. However, the reversal can be limited to a protected, task-specific environment. This privacy friendliness can be a very attractive feature in a banking setting as it does not facilitate modelers and analysts to view names and payment profiles of the customers. In addition, the consumer network data, and the bipartite graph, would be useless to almost any recipient in the case of a data breach.

### Exemplary Inferring Characteristics

The ATM-based consumer network inference approach of the exemplary systems, methods and computer-accessible mediums, according to the exemplary embodiments of the present disclosure, can use the connections between nodes in a consumer network to infer characteristics about the nodes. For example, the linkages between Card nodes can be used to gather information and characteristics about the current customers who use a particular ATM node. The information can be obtained from information that the bank currently has on the customer, or it can be gleaned by any known method of determining data about a particular user. For example, a bank can have information about a customer that has applied for a loan, or a customer who has a savings account. This additional information can enrich the inferred characteristics of other consumers. The more information available about current customers of a particular ATM node, the better the inference. The information and characteristics can be aggregated to infer general information and characteristics about all of the users of a particular ATM node (e.g., users of a particular ATM generally can have similar demographics, income, savings, buying habits, and/or product preferences, although not limited thereto). While this data may or may not be correct for each user of the particular node, it can generally produce accurate estimates in the aggregate. This can facilitate the exemplary systems, methods and computer-accessible mediums to glean information about a particular node without requiring any knowledge about the surrounding area. For example, the exemplary systems, methods and computer-accessible mediums can determine that a neighborhood can be affluent based on the customer use of a particular ATM, without any knowledge of the neighborhood itself.

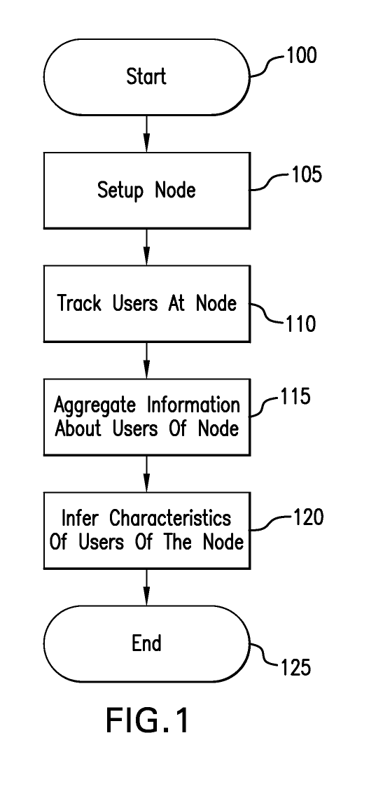

FIG. 1 shows an exemplary flow diagram of a method for inferring information about consumers according to an exemplary embodiment of the present disclosure. The exemplary method begins at block 100. At procedure 105, a node can be setup for users to access. Nodes can include, for example, ATMs, stores, or generally any place that a user can access and/or make purchases, although not limited thereto, and can be setup by geographic or physical location. At procedure 110, users of the node, who can be customers, can be tracked, and the information on which users use the node can be stored. At procedure 115, the existing information about the customers that use the particular node can be aggregated, and information and characteristics on existing customers can be inferred at procedure 120. At block 125, the exemplary method ends, and the inferred information can be stored for later use.

Once the aggregate information and characteristics about the current customers has been determined, it can be applied to any prospective customers (e.g., people who are not current customers of the bank). When a prospective customer uses an ATM of the bank, the bank can apply the information and characteristics of the current customers that use that particular ATM machine to the prospective customer. The bank can then use the information to attempt to procure the consumer (e.g., offer the consumer goods, services, coupons, or other enticements to get him/her to become a customer).

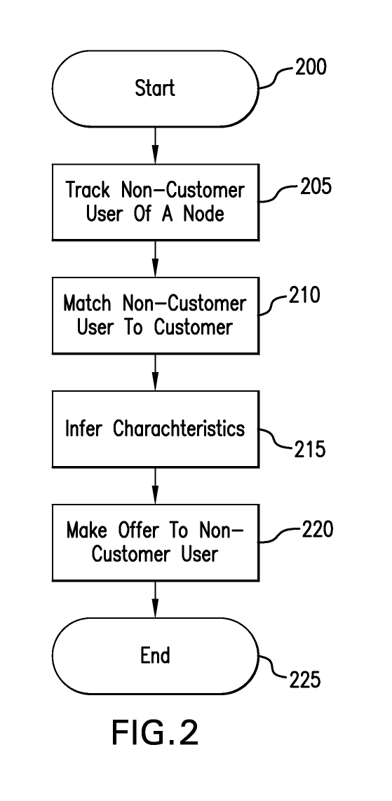

FIG. 2 shows an exemplary flow diagram of a method for new customer acquisition targeting according to an exemplary embodiment of the present disclosure. At block 200, new customer targeting commences. At procedure 205, a non-customer user of a node is tracked. The non-customer user can be tracked at a single node, or the non-customer user can be tracked across multiple nodes if the non-customer user uses multiple nodes. At procedure 210, the non-customer user is matched to one or more users of the same one or more nodes. At procedure 215, information and characteristics of the non-customer users can be inferred based on the information and characteristics of customer users who use the one or more nodes. At procedure 220, an offer can be made to the non-customer user. At block 225, the new customer acquisition targeting can end.

The use of inferred values, instead of observed values, can improve many subsequent analyses, as it can be a mechanism that leverages the principle that people are similar to people who frequent the same locations. (See, e.g., References 13; 18). For example, a 50 year old person who frequents the same locations as mainly 20-30 year old persons can possibly exhibit behavior more characteristic of a younger person than of a 50 year old person. Using the inferred value for age, or other characteristics within analytics applications, can therefore yield better results.

The exemplary implementation methodology can make use of the ATM-based consumer network, and can vary with increasing complexity which can include: (i) Descriptive statistics over neighbors (e.g., using the average or mode of the values for the variable of the network neighbors), (ii) Relational learning/relational inference (e.g., using for learning/inference the weighted average, weighted over the strength of the connections), and (iii) Relational learning and collective inference (e.g., advanced network learners which can also take into account linkages of higher degree). (See, e.g., Reference #11). Option 3 above can be especially useful when only a small part of the population has the specific data characteristic available to infer. The last option above can infer characteristics on the neighbors of the nodes over the complete consumer network.

Two exemplary methods/procedures can be used to infer the value of a continuous variable; the extension to a discrete variable can be obvious. The first method/procedures can take as a value the average over all network neighbors. The second method/procedures can use a weighted average weighted over the strength of the links. The above exemplary metrics can be defined by equations 1 and 2 below, where xᵢⱼ can denote the value of variable j for instance xᵢ, and N(xᵢ) can be the neighborhood of data instance xᵢ, where the strength of the connection to neighbor xₖ can be given by the weight wᵢₖ.

$$\begin{matrix}{x}_{ij}^{Avg} = \frac{{\sum }_{k ∈ N ( {x}_{i} )} {x}_{kj}}{\vert N ( {x}_{i} ) \vert} & ( 1 ) \\ {x}_{ij}^{W , Avg} = \frac{{\sum }_{k ∈ N ( {x}_{i} )} {w}_{ik} \cdot {x}_{kj}}{{\sum }_{k ∈ N ( {x}_{i} )} {w}_{ik}} & ( 2 )\end{matrix}$$

The exemplary performance of the design can be measured in two general ways. First, for example, by comparing the observed characteristic with the predicted characteristics on a test set (e.g., only on possible test instances where the observed characteristics are available). Second, for example, by assessing the performance of second stage analyses that can use these inferred values. Referring to the age example above where there is a limited set of customers with the age value given, and a churn prediction model is to be built, the first exemplary evaluation can look at the prediction error (e.g., mean absolute error (“MAE”), mean square error (“MSE”) mean relative error, R², etc.) in age, for a test set (e.g., small test set), while the second exemplary evaluation can compare the predictions of a churn prediction model using the inferred age with a model that uses the observed age.

In the case study described herein below, the first exemplary approach is used, assessing the accuracy of the inferred variable in terms of MAE and MSE. These values can be compared to the MAE and MSE of a procedure that simply predicts the average value. The ratio of these numbers provides a lift metric, indicating an increase in individual-specific inference as compared to inferring the average for everyone.

### Exemplary Results

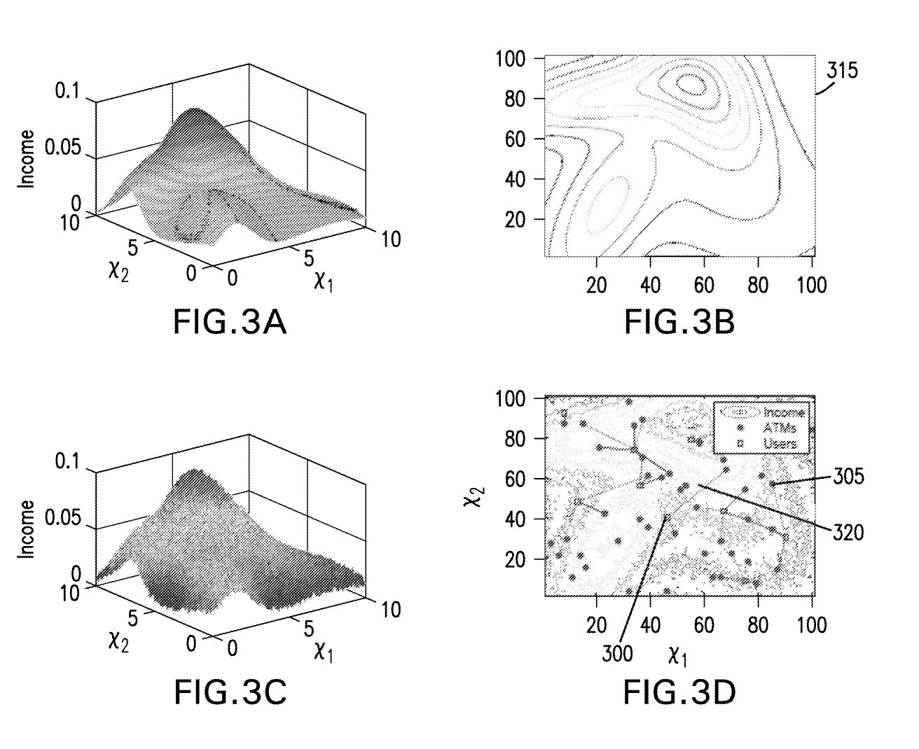

A synthetic city area in which people live with varying incomes was defined, where the income was defined as a function of the location within the grid. FIG. 3A shows an exemplary graph illustrating that this exemplary income distribution can be a mix of four multivariate normal probability density functions. The contour lines 315 of this income (e.g., lines of equal income) are shown in an exemplary graph of FIG. 3B. Some random noise is added to this income distribution, resulting in the income distribution shown in an exemplary graph of FIG. 3C, with contours provided in an exemplary graph of FIG. 3D, where users make cash withdrawals at ATMs (e.g., indicated by lines), chosen proportional to the distance between the ATM and the user's location. A number of persons (^{└}) 300 and ATMs (•) 305 can be randomly created within this grid. Users can choose the ATMs to withdraw money from with a probability based on the distance (e.g., 2-norm) between the user and the ATM. As such, for each ATM transaction, a roulette wheel selection can determine which ATM can be chosen. The number of ATM transactions per user can also be randomly chosen based on a normal distribution with an average of about 10 transactions and a standard deviation of about 2.5 (e.g., chosen as the average divided by 4). The resulting ATM withdrawals are shown in an exemplary graph of FIG. 3D by lines 320 between users and ATMs.

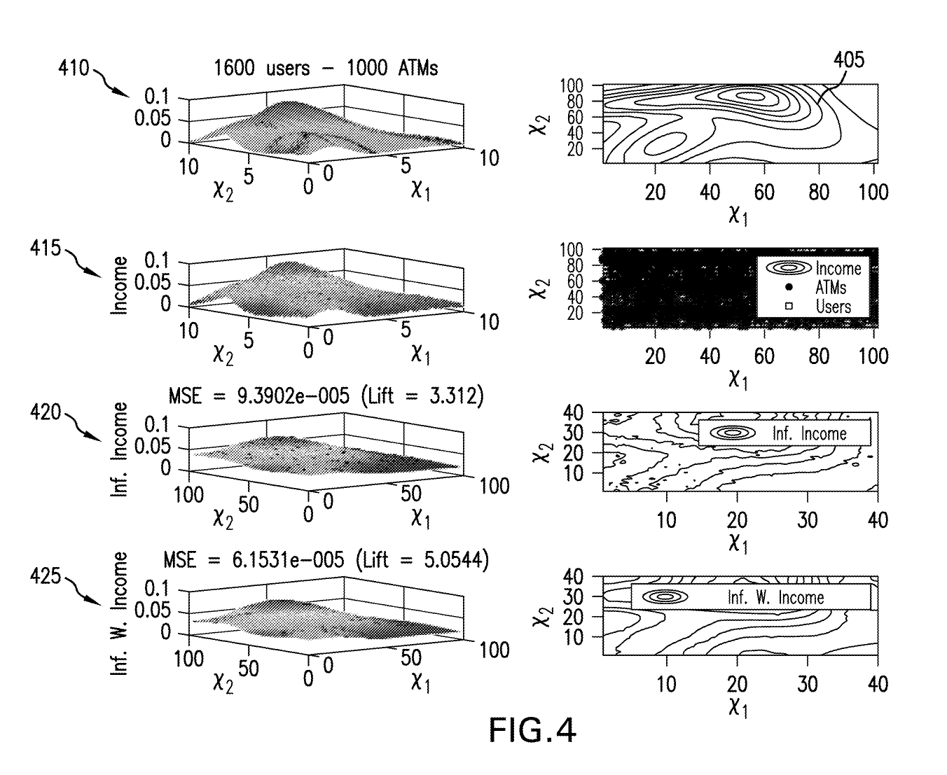

To assess the exemplary methodology above, a leave-one-out approach can be employed. For each user xᵢ, it can be assumed that the income value for all other users can be known. Based on the users in the neighborhood of xᵢ, N(xᵢ) (e.g., those users that share at least one ATM with user xᵢ), the income value can be inferred according to equations 1 and 2. FIG. 4 shows a set of exemplary graphs of the income distribution 410, the income distribution with noise 415, the inferred income when using the average income over N(xᵢ) 420, and the inferred income when using the weighted average income over N(xᵢ) 425.

The best exemplary result can be obtained for the weighted version (e.g., lift of 5.1 in terms of MSE). The contour lines 405, shown on the right side graph(s) of FIG. 4 of the weighted version, can mimic the original income distribution much better, seemingly able to get rid of the noise present in the data. For this relatively high number of users, the non-weighted version can have a much flatter inferred income, as no distinction is made between nearby and far-away network neighbors.

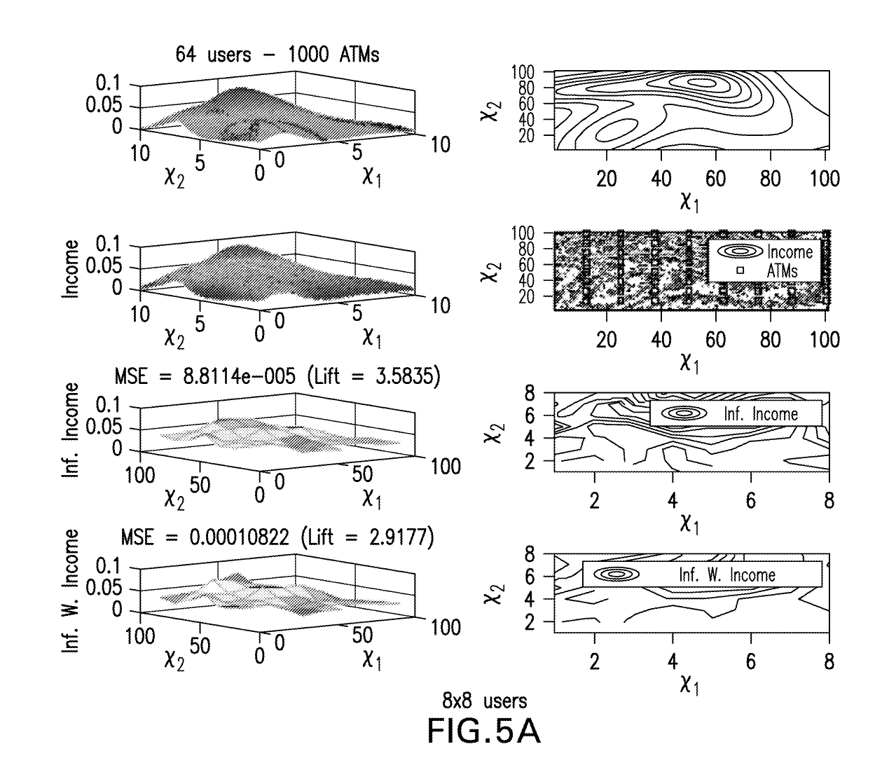

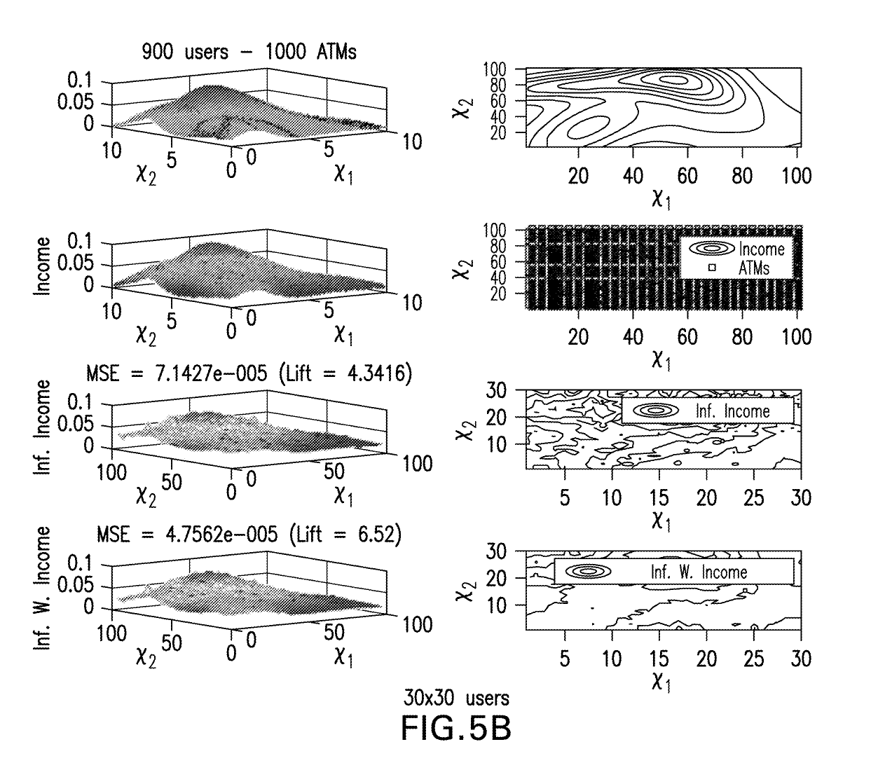

FIGS. 5A and 5 B show exemplary graphs and results for grids of 8 by 8 and 30 by 30 users. When considering 900 users, better lifts can be observed for the weighted version as compared to the non-weighted version one. When considering only 64 users, the non-weighted version can perform better. This can be because when many users are available, the more fine-grained estimate of the weighted inferred variable can be better.

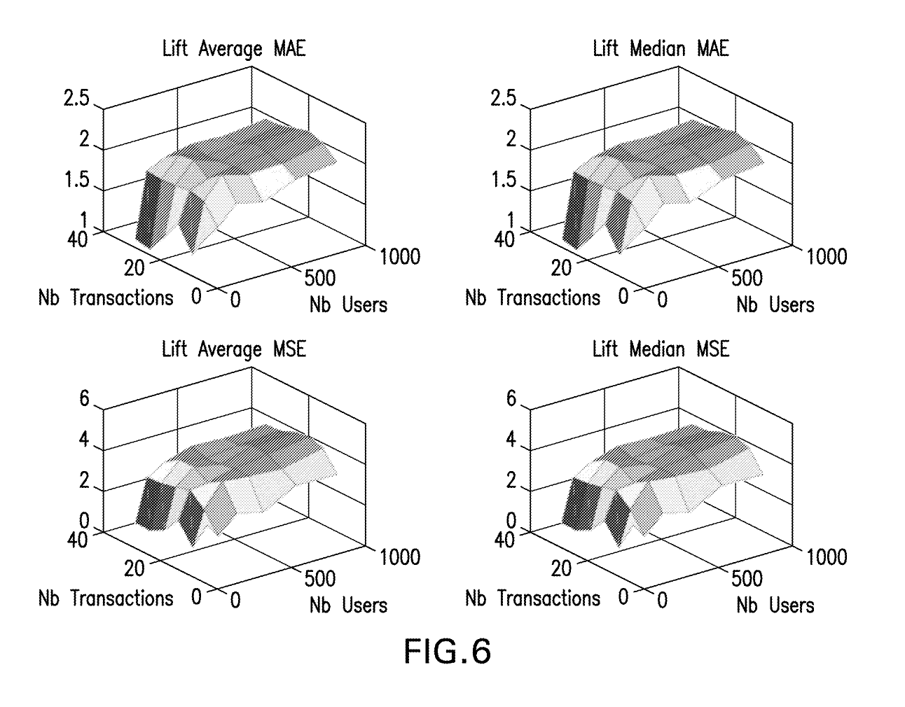

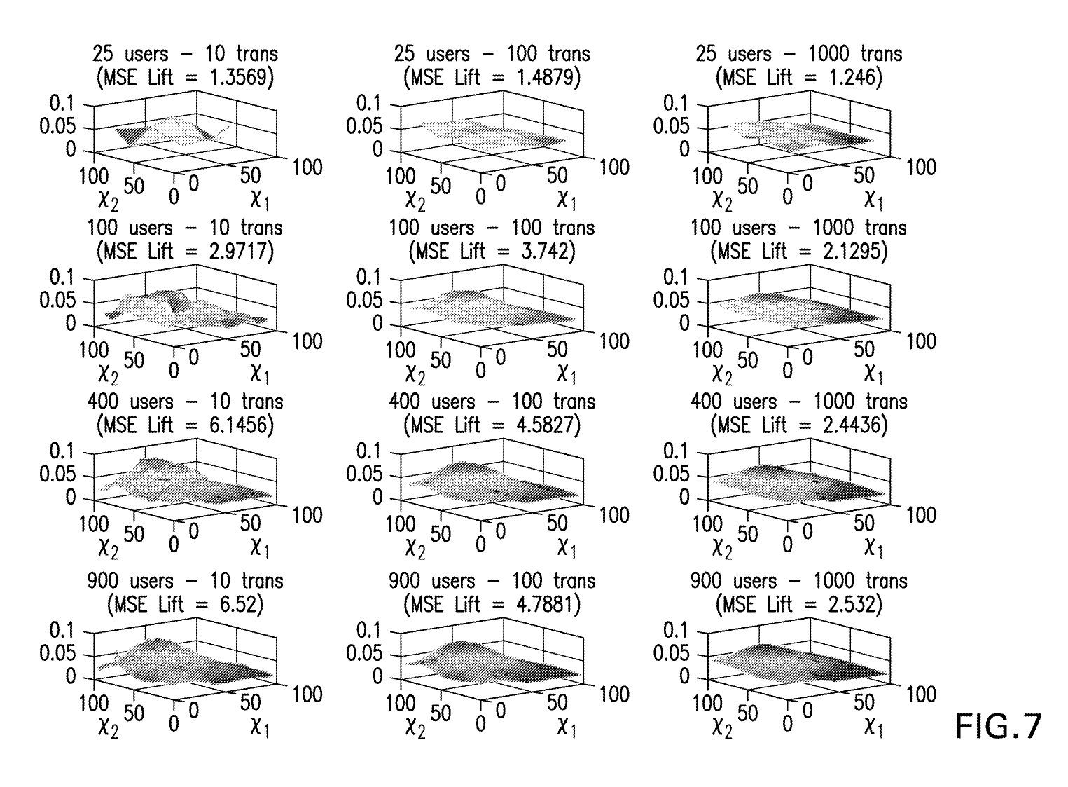

Next, the impact of the number of users and the number of transactions can be considered, with the number of ATMs set at 1000. A ten-fold experimental setup can be conducted where, for each setting of number of transactions and number of users, the users, ATMs and transactions are randomly generated. The average and median can be calculated over the set of 10 MSE and MAE values per setting, which can correspond to the exemplary graphs of FIG. 6. FIG. 7 illustrates exemplary graphs indicating how the distribution of inferred income can change for an increasing number of users (e.g., from top to bottom), and for an increasing number of transactions (e.g., from left to right). The exemplary results can show that having more users, and more transactions, can improve the performance, although there can be some reduction in performance from about 20 or more transactions per user. When users use more ATMs, more network neighbors can be created, sometimes in areas far away from its location, which could explain why there is some reduced performance. This phenomenon can also be observed in the exemplary graphs of FIG. 7, where more transactions can lead to a flattening effect in the inferred variable distribution.

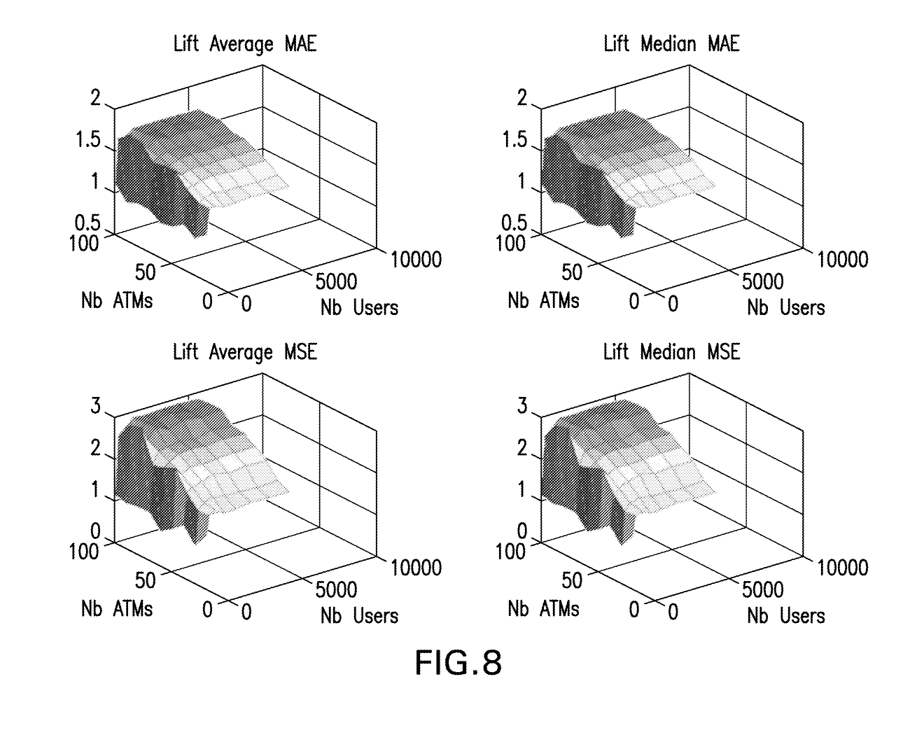

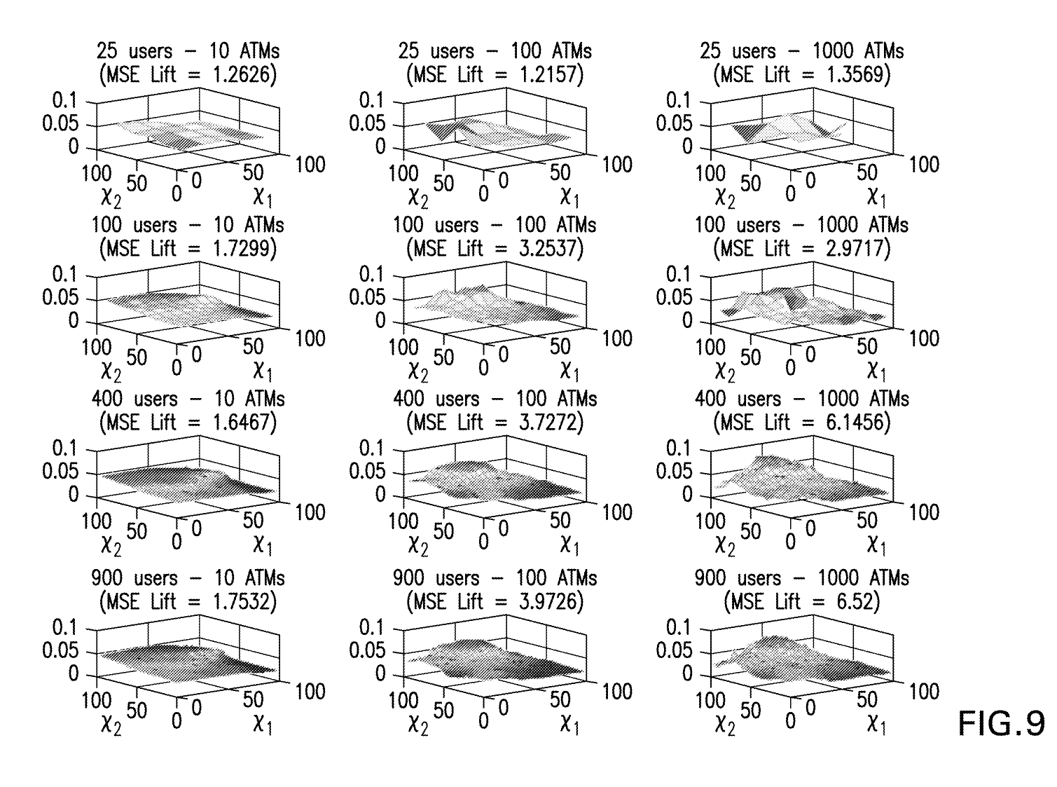

FIG. 8 shows exemplary graphs indicating an exemplary impact of varying the number of users and ATMs, with the number of transactions set at 10. Increasing the number of ATMs has a clear monotone effect. This improved performance is also clear in the inferred variable distributions shown in exemplary graphs of FIG. 9 where the number of ATMs increases from left to right. The increase in the number of users only has an impact for the low range, after which the performance remains flat.

The exemplary systems, methods, and computer-accessible mediums can be beneficial as they take advantage of the fact that in terms of predicting an unknown quantity, the attributes of one's “network neighbors” can be more predictive than one's own attributes. As such, the inferred data can have more predictive power than the observed data. Additionally, data may not be available for particular nodes in a network. The exemplary systems, methods, and computer-accessible mediums facilitate data to be gathered about the usage of a particular node without having any previous data about the node. The relational data between customer usages of a particular node can be used to infer information, unlike approaches that attempt to impute the missing information.

The exemplary systems, methods, and computer-accessible mediums could be used to provide product recommendations, but provide distinct advantages over prior art methods, for example, collaborative filtering, which creates a similarity measures between customers in order to recommend products based on similarities in purchases or ratings of these products. While collaborative filtering uses similarity within a certain of products (e.g., books) to generate predictions, the exemplary systems, methods, and computer-accessible mediums can use very different information (e.g., information about use of an ATM) in order to generate recommendations.

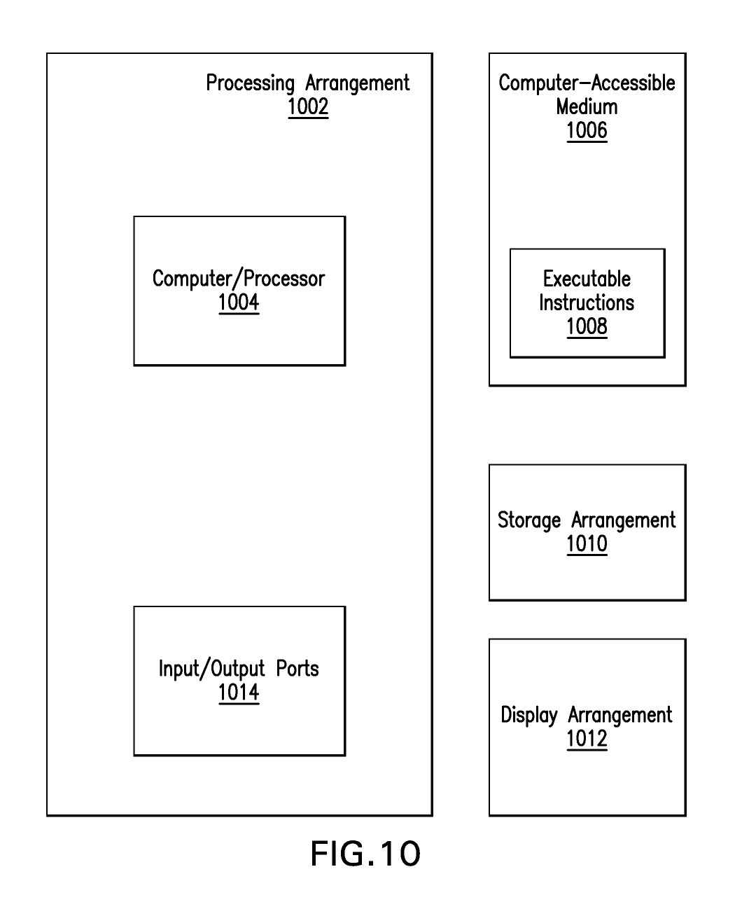

FIG. 10 shows a block diagram of an exemplary embodiment of a system according to the present disclosure. For example, exemplary procedures in accordance with the present disclosure described herein can be performed by a processing arrangement and/or a computing arrangement 1002. Such processing/computing arrangement 1002 can be, for example, entirely or a part of, or include, but not limited to, a computer/processor 1004 that can include, for example, one or more microprocessors, and use instructions stored on a computer-accessible medium (e.g., RAM, ROM, hard drive, or other storage device).

As shown in FIG. 10, for example, a computer-accessible medium 1006 (e.g., as described herein above, a storage device such as a hard disk, floppy disk, memory stick, CD-ROM, RAM, ROM, etc., or a collection thereof) can be provided (e.g., in communication with the processing arrangement 1002). The computer-accessible medium 1006 can contain executable instructions 1008 thereon. In addition or alternatively, a storage arrangement 1010 can be provided separately from the computer-accessible medium 1006, which can provide the instructions to the processing arrangement 1002 so as to configure the processing arrangement to execute certain exemplary procedures, processes and methods, as described herein above, for example.

Further, the exemplary processing arrangement 1002 can be provided with or include an input/output arrangement 1014, which can include, for example, a wired network, a wireless network, the interne, an intranet, a data collection probe, a sensor, etc. As shown in FIG. 10, the exemplary processing arrangement 1002 can be in communication with an exemplary display arrangement 1012, which, according to certain exemplary embodiments of the present disclosure, can be a touch-screen configured for inputting information to the processing arrangement in addition to outputting information from the processing arrangement, for example. Further, the exemplary display 1012 and/or a storage arrangement 1010 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following references are hereby incorporated by reference in their entireties.
1. Berger, P. et al., “Customer Lifetime Value: Marketing Models And Applications”, Journal of Interactive Marketing 12(1), 17-30, (1998).
2. Bijmolt et al., “Analytics For Customer Engagement”, Journal of Service Research 13(3), 341-356, (2010).
3. Blattberg, R. C. et al., “Database Marketing: Analyzing and Managing Customers”, Springer Verlag, New York, (2008).
4. Dasgupta, K. et al., “Social Ties And Their Relevance To Churn In Mobile Telecom Networks”, Proceedings Of The 11th International Conference On Extending Database Technology: Advances In Database Technology, pp. 668-677, (2008).
5. Fader, P. S. et al., “Rfm And Clv: Using Isovalue Curves For Customer Base Analysis”, Journal of Marketing Research 42(4), 415-430, (2005).
6. Gupta, S. et al., “Modeling Customer Lifetime Value”, Journal of Service Research 9(2), 139-155, (2006).
7. Hill, S. et al., “Network-Based Marketing: Identifying Likely Adopters Via Consumer Networks”, Statistical Science 22, 256-276, (2006).
8. Knott, A. et al., “Next-Product-To-Buy Models For Cross-Selling Applications”, Journal of Interactive Marketing, 16(3), 59-75, (2002).
9. Kumar, V. et al., Journal of Service Research 9(2), 87-94, (2006).
10. Lewis, M. et al., “Customer Acquisition Promotions And Customer Asset Value”, Journal of Marketing Research 43(2), 195-203, (2006).
11. Macskassy, S. A. et al., “Suspicion scoring based on guilt-by-association, collective inference”, Proceedings of the First International Conference on Intelligence Analysis (IA).
12. Martens, D. et al., “Pseudo-social network targeting from consumer transaction data”, Working paper CeDER-11-05, New York University Stern School of Business, (2011).
13. McPherson, M. et al., “Birds Of A Feather: Homophily In Social Networks”, Annual Review of Sociology 27(1), 415-444, (2001).
14. Moe, W. et al., “Dynamic Conversion Behavior At E-Commerce Sites”, Management Science 50(3), 326-335, (2004).
15. Neslin, S. A. et al., “Challenges and Opportunities in Multichannel Customer Management”, Journal of Service Research 9(2), 95-112, (2006).
16. Neslin, S. et al., “Key Issues In Multichannel Customer Management: Current Knowledge And Future Directions”, Journal of Interactive Marketing 23, 70-81, (2009).
17. Netzer, O. et al., “A Hidden Markov Model Of Customer Relationship Dynamics”, Marketing Science 27(2), 185-204, (2008).
18. Provost, F. et al., “Geo-social targeting for privacy-friendly mobile advertising: Position paper”, Working paper CeDER-11-06A, NYU Stern and Coriolis Labs, (2011).
19. Provost, F. et al., “Audience selection for on-line brand advertising: privacy-friendly social network targeting”, KDD 09: Proceedings of the 15th ACM SIGKDD international conference on Knowledge discovery and data mining, pp. 707-716, (2009).
20. Thomas, J. S. et al., “Recapturing Lost Customers”, Journal of Marketing Research 41(1), 31-45, (2004).
21. Thorleuchter, D., et al., “Analyzing Existing Customers Websites To Improve The Customer Acquisition Process As Well As The Profitability Prediction In B-To-B Marketing”, Expert Systems with Applications 39(3), 2597-2605, (2012).
22. Verbeke, W. et al., “New Insights Into Churn Prediction In The Telecommunication Sector: A Profit Driven Data Mining Approach”, European Journal of Operational Research 218(1), 211-229, (2012).
23. Verbeke, W., et al., “Building Comprehensible Customer Churn Prediction Models With Advanced Rule Induction Techniques”, Expert Systems with Applications 38(3), 2354-2364, (2011).
24. Villanueva, J. et al., “The Impact Of Marketing-Induced Versus Word-Of-Mouth Customer Acquisition On Customer Equity Growth”, Journal of Marketing Research 45(1), 48-59, (2008).
25. Wei, C.-P. et al., “Turning Telecommunications Call Details To Churn Prediction: A Data Mining Approach”, Expert Systems with Applications 23(2), 103-112, (2002).

What is claimed is:

1. A non-transitory computer-accessible medium having stored thereon computer-executable instructions for customer acquisition or data inference using social targeting, wherein, when a computer hardware arrangement executes the instructions, the computer arrangement is configured to perform procedures comprising:
a. receiving first information relating to at least one customer user associated with at least one particular node;
b. determining second information based, at least in part, on the first information;
c. receiving third information related to at least one non-customer user associated with the at least one particular node; and
d. determining fourth information based, at least in part, on the second information and the third information.

2. The computer-accessible medium of claim 1, wherein the first information includes at least one characteristic of the at least one customer user.

3. The computer-accessible medium of claim 2, wherein the at least one characteristic includes at least one of (i) demographics, (ii) income, (iii) savings amount, (iv) buying habits or (v) product preferences.

4. The computer-accessible medium of claim 1, wherein the at least one customer user includes a plurality of customer users, and wherein the computer arrangement is further configured to determine the second information by aggregating at least one characteristic of the plurality of customer users associated with the at least one particular node.

5. The computer-accessible medium of claim 1, wherein the computer arrangement is further configured to determine the second information using a bipartite graph.

6. The computer-accessible medium of claim 5, wherein top nodes of the bipartite graph correspond to at least one automated teller machine, and bottom nodes of the bipartite graph correspond to at least one bank card of the at least one customer user.

7. The computer-accessible medium of claim 1, wherein the third information includes a usage of the at least one particular node by the at least one non-customer user.

8. The computer-accessible medium of claim 1, wherein the computer arrangement is further configured to determine the fourth information by using at least one characteristic of the at least one customer user to infer at least one characteristic of the at least one non-customer user.

9. The computer-accessible medium of claim 8, wherein the fourth information includes at least one of (i) demographics, (ii) income, (iii) savings amount, (iv) buying habits, or (v) product preferences of the at least one non-customer user.

10. The computer-accessible medium of claim 1, wherein the at least one particular node includes a plurality of particular nodes.

11. The computer-accessible medium of claim 10, wherein the computer arrangement is further configured to determine the second information based on the plurality of particular nodes.

12. The computer accessible medium of claim 10, wherein the computer arrangement is further configured to determine the fourth information using at least one of an average or a weighted average of information related to the plurality of particular nodes.

13. The computer-accessible medium of claim 1, wherein the at least one particular node includes at least one automated teller machine.

14. The computer-accessible medium of claim 1, wherein the at least one particular node has a particular geo-location.

15. The computer-accessible medium of claim 1, wherein the at least one non-customer user is targeted for acquisition as a customer.

16. The computer-accessible medium of claim 1, wherein the computer arrangement is further configured to target the at least one non-customer user to provide at least one of an offer or an advertisement to the at least one non-customer user.

17. The computer-accessible medium of claim 10, wherein the at least one non-customer user is tracked at the plurality of particular nodes.

18. The computer-accessible medium of claim 1, wherein the computer hardware arrangement is further configured to determine the fourth information to socially target the at least one non-customer user.

19. A method, comprising:
a. receiving first information regarding at least one customer user associated with at least one particular node;
b. determining second information based, at least in part, on the first information;
c. receiving third information regarding at least one non-customer user associated with the at least one particular node; and
d. using a computer hardware arrangement, determining fourth information based, at least in part, on the second information and the third information.

20. A system, comprising:
a computer hardware arrangement configured to:
a. receive first information regarding at least one customer user associated with at least one particular node;
b. determine second information based, at least in part, on the first information;
c. receive third information regarding at least one non-customer user associated with the at least one particular node; and
d. determine fourth information based, at least in part, on the second information and the third information.
